(19) United States
(12) Patent Application Publication
(10) Pub. No.: US 2025/0266715 A1
(43) Pub. Date: Aug. 21, 2025

(54) Wireless Power Transfer Coil with Insulated Conductive Wires

(71) Applicant: Apple Inc., Cupertino, CA (US)

(72) Inventors: Saining Ren, Auckland (NZ); Brennan K. Vanden Hoek, Tamarack, CA (US); Ho Fai Leung, Auckland (NZ)

(21) Appl. No.: 18/788,863

(22) Filed: Jul. 30, 2024

Related U.S. Application Data
(60) Provisional application No. 63/553,807, filed on Feb. 15, 2024.

(51) Int. Cl. H02J 50/10; H01F 27/24; H01F 27/28; H02J 50/00

(52) U.S. Cl. CPC H02J 50/10; H01F 27/24; H01F 27/2823; H02J 50/005

(57) ABSTRACT

A wireless charging system may include a wireless power receiving device that receives wireless power signals from a wireless power transmitting device. The wireless power receiving device and the wireless power transmitting device may each include a wireless power transfer coil that comprises windings of a wire bundle having multiple wire units, each wire unit having multiple wire subunits, and each wire subunit having multiple insulated conductive wires.

This application claims the benefit of U.S. provisional patent application No. 63/553,807, filed Feb. 15, 2024, which is hereby incorporated by reference herein in its entirety.

### FIELD

This relates generally to power systems and, more particularly, to wireless power systems for charging electronic devices.

### BACKGROUND

In a wireless charging system, a wireless power transmitting device transmits wireless power to a wireless power receiving device. The wireless power receiving device charges a battery and/or powers components using the wireless power. Each one of the wireless power receiving device and the wireless power transmitting device includes a wireless power transfer coil. Efficient coupling between the wireless power transfer coils in the wireless power transmitting device and the wireless power receiving device can beneficially promote charge performance, reducing charging time.

### SUMMARY

A wireless power transmitting device may be configured to provide wireless power to a wireless power receiving device. The wireless power transmitting device may include a wireless power transfer coil and inverter circuitry coupled to the wireless power transfer coil. The wireless power transfer coil may include windings of a wire bundle, the wire bundle may include a plurality of wire units that twist along a length of the wire bundle, each wire unit of the plurality of wire units may include wire subunits that twist along a length of that wire unit, and each wire subunit of the plurality of wire subunits comprises a plurality of insulated conductive wires that twist along a length of that wire subunit.

A wireless power receiving device may be configured to receive wireless power from a wireless power transmitting device. The wireless power receiving device may include a wireless power transfer coil and rectifier circuitry coupled to the wireless power transfer coil. The wireless power transfer coil may include windings of a wire bundle, the wire bundle may include a plurality of wire units that twist along a length of the wire bundle, each wire unit of the plurality of wire units may include wire subunits that twist along a length of that wire unit, and each wire subunit of the plurality of wire subunits comprises a plurality of insulated conductive wires that twist along a length of that wire subunit.

### BRIEF DESCRIPTION OF THE DRAWINGS

FIG. 1 is a schematic diagram of an illustrative wireless power system in accordance with some embodiments.

FIG. 2 is a circuit diagram of wireless power transmitting and receiving circuitry in accordance with some embodiments.

FIG. 3 is a cross-sectional side view of an illustrative wire bundle for a wireless power transfer coil in accordance with some embodiments.

FIG. 4 is a top view of an illustrative wireless power transfer coil with windings of the wire bundle of FIG. 3 arranged in a plurality of turns in accordance with some embodiments.

FIGS. 5A-5C are cross-sectional side views of a single wire subunit showing the varying radial positions of an insulated conductive wire at different points along the wire bundle of FIGS. 3 and 4 in accordance with some embodiments.

FIGS. 6A-6C are cross-sectional side views of a single wire unit showing the varying radial positions of a wire subunit at different points along the wire bundle of FIGS. 3 and 4 in accordance with some embodiments.

FIGS. 7A-7C are cross-sectional side views of the wire bundle of FIGS. 3 and 4 showing the varying radial positions of a wire unit at different points along the wire bundle in accordance with some embodiments.

FIGS. 8A-8C are cross-sectional side views of the wire bundle of FIGS. 3 and 4 showing the varying radial positions of an insulated conductive wire at different points along the wire bundle in accordance with some embodiments.

FIG. 9 is a cross-sectional side view of an illustrative wireless charging system with a power transmitting device and a power receiving device in accordance with some embodiments.

FIG. 10 is a top view of an illustrative ring-shaped ferrite core in accordance with some embodiments.

FIG. 11A is a side view of an illustrative wireless power transfer coil with a ferrite core having only one lip in accordance with some embodiments.

FIG. 11B is a side view of an illustrative wireless power transfer coil with a ferrite core having no lips in accordance with some embodiments.

### DETAILED DESCRIPTION

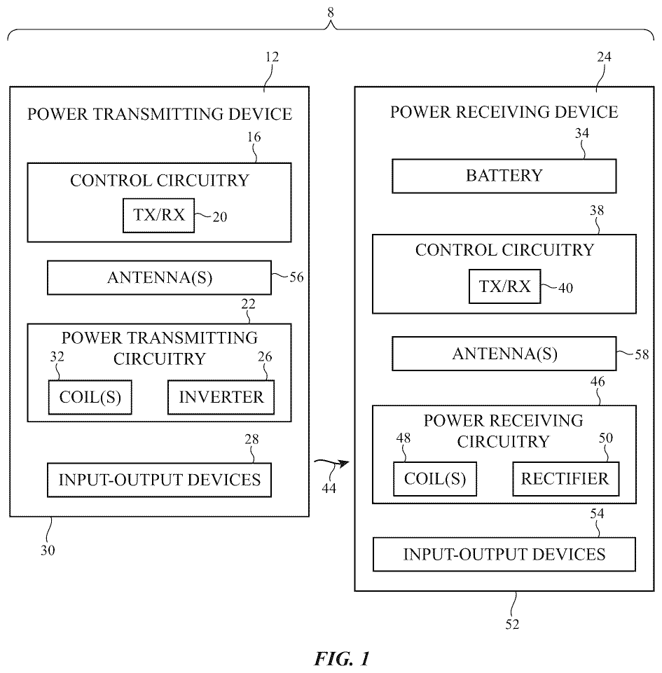

An illustrative wireless power system (also sometimes called a wireless charging system) is shown in FIG. 1. As shown in FIG. 1, wireless power system 8 may include one or more wireless power transmitting devices such as wireless power transmitting device 12 and one or more wireless power receiving devices such as wireless power receiving device 24. Wireless power system 8 may sometimes also be referred to herein as wireless power transfer (WPT) system 8 or wireless power system 8. Wireless power transmitting device 12 may sometimes also be referred to herein as power transmitter (PTX) device 12 or simply as PTX 12. Wireless power receiving device 24 may sometimes also be referred to herein as power receiver (PRX) device 24 or simply as PRX 24.

PTX device 12 includes control circuitry 16. Control circuitry 16 is mounted within housing 30. PRX device 24 includes control circuitry 38 mounted within a corresponding housing 52 for PRX device 24. Exemplary control circuitry 16 and control circuitry 38 are used in controlling the operation of WPT system 8. This control circuitry may include processing circuitry that includes one or more processors such as microprocessors, power management units, baseband processors, digital signal processors, microcontrollers, graphics processing units (GPUs), central processing units (CPUs), application processors (APs), application-specific integrated circuits with processing circuits, and/or other processing circuits. The processing circuitry implements desired control and communications features in PTX device 12 and PRX device 24. For example, the processing circuitry may be used in controlling power to one or more coils, determining and/or setting power transmission levels, generating and/or processing sensor data (e.g., to detect foreign objects and/or external electromagnetic signals or fields), processing user input, handling negotiations between PTX device 12 and PRX device 24, sending and receiving in-band and out-of-band data, making measurements, and/or otherwise controlling the operation of WPT system 8.

Control circuitry in WPT system 8 (e.g., control circuitry 16 and/or 38) is configured to perform operations in WPT system 8 using hardware (e.g., dedicated hardware or circuitry), firmware and/or software. Software code for performing operations in WPT system 8 is stored on non-transitory computer readable storage media (e.g., tangible computer readable storage media) in the control circuitry of WPT system 8. The software code may sometimes be referred to as software, data, program instructions, instructions, or code. The non-transitory computer readable storage media may include non-volatile memory such as non-volatile random-access memory (NVRAM), one or more hard drives (e.g., magnetic drives or solid state drives), one or more removable flash drives or other removable media, or the like. Software stored on the non-transitory computer readable storage media may be executed on the processing circuitry of control circuitry 16 and/or 38.

PTX device 12 may be a stand-alone power adapter (e.g., a wireless charging mat or charging puck that includes power adapter circuitry), may be a wireless charging mat or puck that is connected to a power adapter or other equipment by a cable, may be an electronic device (e.g., a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses, goggles, or other equipment worn on a user's head, or other wearable or miniature device, a television, a computer display that does not contain an embedded computer, a gaming device, a navigation device, a wireless internet-connected voice-controlled speaker, a home entertainment device, a remote control device, a gaming controller, a peripheral user input device, a wireless base station or access point, equipment that implements the functionality of two or more of these devices, or other electronic equipment), may be equipment that has been incorporated into furniture, a vehicle, or other system, may be a removable battery case, or may be other wireless power transfer equipment.

PRX device 24 may be an electronic device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses, goggles, or other equipment worn on a user's head, or other wearable or miniature device, a wireless tracking tag, a television, a computer display that does not contain an embedded computer, a gaming device, a navigation device, a wireless internet-connected voice-controlled speaker, a home entertainment device, a remote control device, a gaming controller, a peripheral user input device, a wireless base station or access point, equipment that implements the functionality of two or more of these devices, or other electronic equipment.

PTX device 12 may be connected to a wall outlet (e.g., an alternating current power source), may be coupled to a wall outlet via an external power adapter, may have a battery for supplying power, and/or may have another source of power. In implementations where PTX device 12 is coupled to a wall outlet via an external power adapter, the adapter may have an alternating-current (AC) to direct-current (DC) power converter that converts AC power from a wall outlet or other power source into DC power. If desired, PTX device 12 may include a DC-DC power converter for converting the DC power between different DC voltages. Additionally or alternatively, PTX device 12 may include an AC-DC power converter that generates the DC power from the AC power provided by the wall outlet (e.g., in implementations where PTX device 12 is connected to the wall outlet without an external power adapter). DC power may be used to power control circuitry 16. During operation, a controller in control circuitry 16 uses power transmitting circuitry 22 to transmit wireless power to power receiving circuitry 46 of PRX device 24.

Power transmitting circuitry 22 may have switching circuitry, such as inverter circuitry 26 formed from transistors, that are turned on and off based on control signals provided by control circuitry 16 to create AC current signals through one or more wireless power transmitting coils such as wireless power transmitting coil(s) 32. These coil drive signals cause coil(s) 32 to transmit wireless power. In implementations where coil(s) 32 include multiple coils, the coils may be disposed on a ferromagnetic structure, arranged in a planar coil array, or may be arranged to form a cluster of coils (e.g., two or more coils, 5-10 coils, at least 10 coils, 10-30 coils, fewer than 35 coils, fewer than 25 coils, or other suitable number of coils). In some implementations, PTX device 12 includes only a single coil 32.

As the AC currents pass through one or more coils 32, alternating-current electromagnetic (e.g., magnetic) fields (wireless power signals 44) are produced that are received by one or more corresponding receiver coils such as coil(s) 48 in PRX device 24. In other words, one or more of coils 32 is inductively coupled to one or more of coils 48. PRX device 24 may have a single coil 48, at least two coils 48, at least three coils 48, at least four coils 48, or another suitable number of coils 48. When the alternating-current electromagnetic fields are received by coil(s) 48, corresponding alternating-current currents are induced in coil(s) 48. The AC signals that are used in transmitting wireless power may have any desired frequency (e.g., 100-400 kHz, 1-100 MHz, between 1.7 MHz and 1.8 MHz, less than 2 MHz, between 100 kHz and 2 MHz, etc.). Rectifier circuitry such as rectifier circuitry 50, which contains rectifying components such as synchronous rectification transistors arranged in a bridge network, converts received AC signals (received alternating-current signals associated with wireless power signals 44) from one or more coils 48 into DC voltage signals for powering PRX device 24. Wireless power signals 44 are sometimes referred to herein as wireless power 44 or wireless charging signals 44. Coils 32 are sometimes referred to herein as wireless power transfer coils 32, wireless charging coils 32, or wireless power transmitting coils 32. Coils 48 are sometimes referred to herein as wireless power transfer coils 48, wireless charging coils 48, or wireless power receiving coils 48.

The DC voltage produced by rectifier circuitry 50 (sometime referred to as rectifier output voltage Vrect) may be used in charging a battery such as battery 34 and may be used in powering other components in PRX device 24 such as control circuitry 38, input-output (I/O) devices 54, etc. PTX device 12 may also include input-output devices such as input-output devices 28. Input-output devices 54 and/or input-output devices 28 may include input devices for gathering user input and/or making environmental measurements and may include output devices for providing a user with output.

As examples, input-output devices 28 and/or input-output devices 54 may include a display (screen) for creating visual output, a speaker for presenting output as audio signals, light-emitting diode status indicator lights and other light-emitting components for emitting light that provides a user with status information and/or other information, haptic devices for generating vibrations and other haptic output, and/or other output devices. Input-output devices 28 and/or input-output devices 54 may also include sensors for gathering input from a user and/or for making measurements of the surroundings of WPT system 8.

The example in FIG. 1 of PRX device 24 including battery 34 is illustrative. More generally, an electronic device may include a power storage device 34. Power storage device 34 may be a battery, or may be, for example, a supercapacitor that stores charge.

PTX device 12 and PRX device 24 may communicate wirelessly using in-band or out-of-band communications. Implementations using in-band communication may utilize, for example, frequency-shift keying (FSK) and/or amplitude-shift keying (ASK) techniques to communicate in-band data between PTX device 12 and PRX device 24. Wireless power and in-band data transmissions may be conveyed using coils 32 and 48 concurrently. When PTX 12 sends in-band data to PRX 24, wireless transceiver (TX/RX) circuitry 20 may modulate wireless charging signal 44 to impart FSK or ASK communications, and wireless transceiver circuitry 40 may demodulate the wireless charging signal 44 to obtain the data that is being communicated. When PRX 24 sends in-band data to PTX 12, wireless transceiver (TX/RX) circuitry 40 may modulate wireless charging signal 44 to impart FSK or ASK communications, and wireless transceiver circuitry 20 may demodulate the wireless charging signal 44 to obtain the data that is being communicated.

Implementations using out-of-band communication may utilize, for example, hardware antenna structures and communication protocols such as Bluetooth or NFC to communicate out-of-band data between PTX device 12 and PRX device 24. Power may be conveyed wirelessly between coils 32 and 48 concurrently with the out-of-band data transmissions. Wireless transceiver circuitry 20 may wirelessly transmit and/or receive out-of-band signals to and/or from PRX device 24 using an antenna such as antenna 56. Wireless transceiver circuitry 40 may wirelessly transmit and/or receive out-of-band signals to and/or from PTX device 12 using an antenna such as antenna 58.

Each one of housing 30 and housing 52 may be formed from plastic, metal, fiber-composite materials such as carbon-fiber materials, wood and other natural materials, glass, other materials, and/or combinations of two or more of these materials.

The example in FIG. 1 of PTX 12 transmitting wireless power and PRX 24 receiving wireless power is merely illustrative. PTX 12 may optionally be capable of receiving wireless power signals using coil(s) 32 and PRX 24 may optionally be capable of transmitting wireless power signals using coil(s) 48. When a device is capable of both transmitting and receiving wireless power signals, the device may include both an inverter and a rectifier.

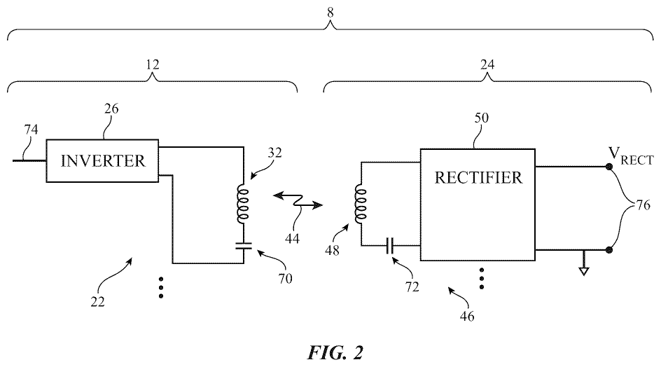

FIG. 2 is a circuit diagram of illustrative wireless charging circuitry for system 8. As shown in FIG. 2, circuitry 22 may include inverter circuitry such as one or more inverters 26 or other drive circuitry that produces wireless power signals that are transmitted through an output circuit that includes one or more coils 32 and capacitors such as capacitor 70. In some embodiments, device 12 may include multiple individually controlled inverters 26, each of which supplies drive signals to a respective coil 32. In other embodiments, an inverter 26 is shared between multiple coils 32 using switching circuitry.

During operation, control signals for inverter(s) 26 are provided by control circuitry 16 at control input 74. A single inverter 26 and single coil 32 is shown in the example of FIG. 2, but multiple inverters 26 and multiple coils 32 may be used, if desired. In a multiple coil configuration, switching circuitry (e.g., multiplexer circuitry) may be used to couple a single inverter 26 to multiple coils 32 and/or each coil 32 may be coupled to a respective inverter 26. During wireless power transmission operations, transistors in one or more selected inverters 26 are driven by AC control signals from control circuitry 16. The relative phase between the inverters may be adjusted dynamically (e.g., a pair of inverters 26 may produce output signals in phase or out of phase).

The application of drive signals using inverter(s) 26 (e.g., transistors or other switches in circuitry 22) causes the output circuits formed from selected coils 32 and capacitors 70 to produce alternating-current electromagnetic fields (signals 44) that are received by wireless power receiving circuitry 46 using a wireless power receiving circuit formed from one or more coils 48 and one or more capacitors 72 in device 24.

Rectifier circuitry 50 is coupled to one or more coils 48 and converts received power from AC to DC and supplies a corresponding direct current output voltage Vrect across rectifier output terminals 76 for powering load circuitry in device 24 (e.g., for charging battery 34, for powering a display and/or other input-output devices 54, and/or for powering other components).

Quality factor is a dimensionless unit that represents ohmic losses of a wireless power transfer coil. To improve efficiency of wireless power transfer, it may be desirable for wireless power transfer coils in system 8 to have as high a quality factor (Q) as possible. A high quality factor for the coil means lower losses, and therefore improved efficiency during wireless power transfer operations. Lowering the resistance associated with a coil increases the quality factor for that coil.

To reduce the resistance and increase the quality factor associated with the wireless power transfer coils in system 8, the wireless power transfer coils may be formed using a wire bundle that comprises a plurality of insulated conductive wires. For simplicity, a coil 32 in PTX 12 will be described in detail below. However, it should be understood that the descriptions for coil 32 also apply to coil 48 in PRX 24. Using a plurality of insulated conductive wires in a wire bundle for coil 32 may help mitigate both the skin effect and proximity effect.

Skin effect causes alternating current to concentrate near the surface of a conductor, reducing its effective cross-sectional area and increasing resistance. Using multiple individually insulated wires grouped together disperses the current across the strands and reduces the skin effect. This reduces power loss and enhances the efficiency of the wireless power transfer system. Proximity effect is a phenomenon that occurs in conductors carrying alternating current (AC) when they are placed close to each other. In particular, the magnetic field generated by the current induces eddy currents in nearby conductors. The proximity effect can lead to increased resistance and power loss.

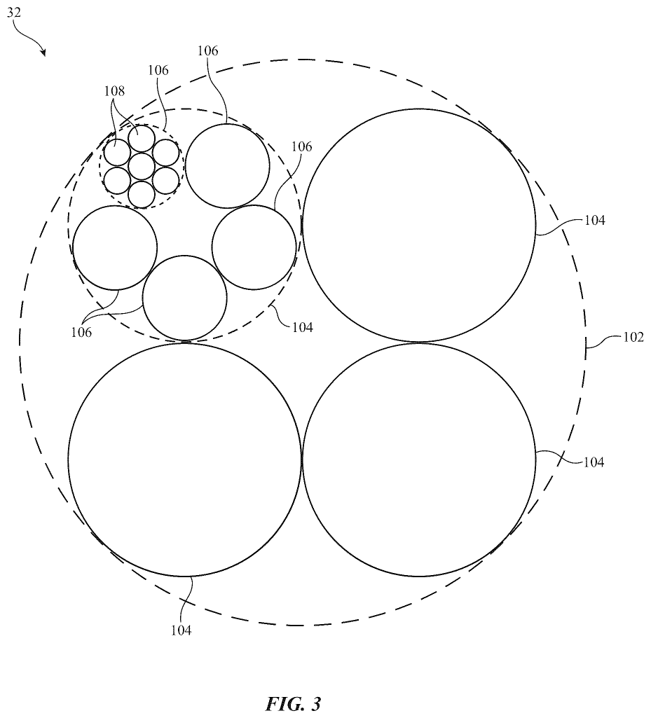

To mitigate increased resistance caused by the skin effect and the proximity effect, the wire bundle for coil 32 may have the arrangement shown in FIGS. 3-11. As shown in FIG. 3, coil 32 may be formed from a wire bundle 102 that includes a plurality of wire units 104, a plurality of wire subunits 106, and a plurality of insulated conductive wires 108. In the illustrated example, a plurality of insulated conductive wires 108 may be grouped together to form a single respective wire subunit 106. A plurality of wire subunits 106 may be grouped together to form a single respective wire unit 104. A plurality of wire units 104 may be grouped together to form wire bundle 102. In the example of FIG. 3, there are seven insulated conductive wires 108 in each wire subunit 106, there are five wire subunits 106 in each wire unit 104, and there are four wire units 104 in wire bundle 102.

For simplicity of the drawing, the individual wire subunits 106 are only explicitly depicted for a single wire unit 104. However, it should be understood that each wire unit includes a plurality of wire subunits 106. Similarly, for simplicity of the drawing, the individual wires 108 are only explicitly depicted for a single wire subunit 106. However, it should be understood that each wire subunit includes a plurality of wires 108.

To mitigate resistance increases caused by the skin effect, each wire subunit may have less than eight insulated conductive wires 108. Including seven wires or less of equal size in each wire subunit results in, at most, one wire in the subunit that is not at an outermost periphery of the wire subunit. In the example of FIG. 3, wire subunit 106 has a single central wire that is surrounded by six wires at the outermost periphery of the wire subunit.

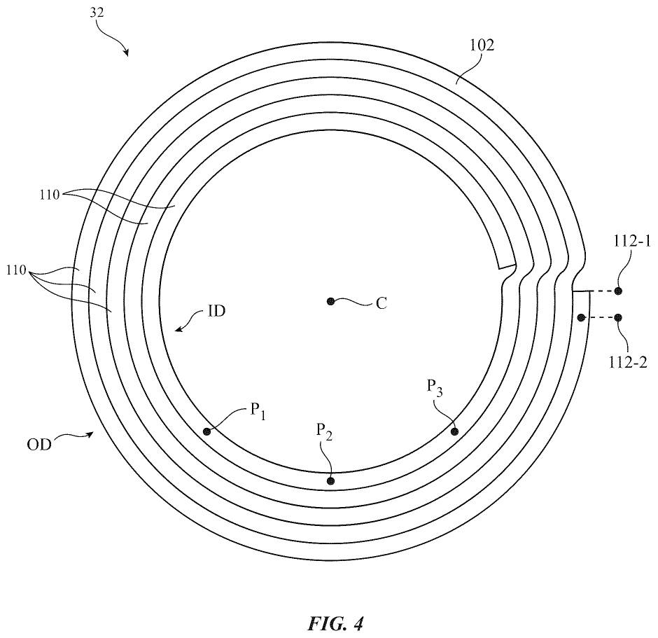

FIG. 4 shows a top view of wireless power transfer coil 32 with windings of wire bundle 102 arranged in a plurality of turns 110. Each turn 110 refers to a loop of wire bundle 102 around the circumference of coil 32. There may be a single layer of turns or multiple layers of turns. The number of layers of turns may be consistent between the inner diameter (ID) of coil 32 and the outer diameter (OD) of coil 32. In one possible arrangement, coil 32 may include one layer of ten turns (e.g., 10 turns total arranged in a single layer). In another possible arrangement, shown in FIG. 4) coil 32 may include two layers of five turns (e.g., 10 turns total arranged in two layers).

Coil 32 may have first and second leads 112 at the inner diameter and/or outer diameter of the coil. Coil 32 may have a geometric center C. FIG. 4 shows an example where leads 112-1 and 112-2 (on opposing ends of the windings of wire bundle 102) are formed at the outer diameter of coil 32. In this example, there are consistently two layers of turns between the inner diameter and the outer diameter of the coil. The first lead 112-1 may be electrically connected to a first end of wire bundle 102 which is part of a first layer of turns (not explicitly shown in FIG. 4) and second lead 112-2 may be electrically connected to a second end of wire bundle 102 which is part of a second layer of turns. Both the first and second ends of wire bundle 102 are at the OD.

In the example of FIG. 4, coil 32 has a circular perimeter for both the inner diameter and outer diameter. This example is merely illustrative. If desired, the inner diameter and/or outer diameter of the coil may have an elliptical perimeter and/or perimeter of another desired shape. The coil may surround a central opening.

Each wire subunit 106, wire unit 104, and wire bundle 102 may be twisted during the formation of wire bundle 102.

After grouping insulated conductive wires together to form a wire subunit 106, the wire subunit may be twisted (e.g., one end of the wire subunit is rotated while the other end of the wire subunit is fixed or rotated the opposite direction). Twisting the wire subunit causes the plurality of insulated conductive wires 108 that comprise the wire subunit 106 to twist along a length of wire subunit 106.

After grouping wire subunits 106 together to form a wire unit 104, the wire unit may be twisted (e.g., one end of the wire unit is rotated while the other end of the wire unit is fixed or rotated the opposite direction). Twisting the wire unit causes the plurality of wire subunits 106 that comprise the wire unit 104 to twist along a length of wire unit 104.

After grouping wire units 104 together to form a wire bundle 102, the wire bundle may be twisted (e.g., one end of the wire bundle is rotated while the other end of the wire bundle is fixed or rotated the opposite direction). Twisting the wire bundle causes the plurality of wire units 104 that comprise the wire bundle 102 to twist along a length of wire bundle 102.

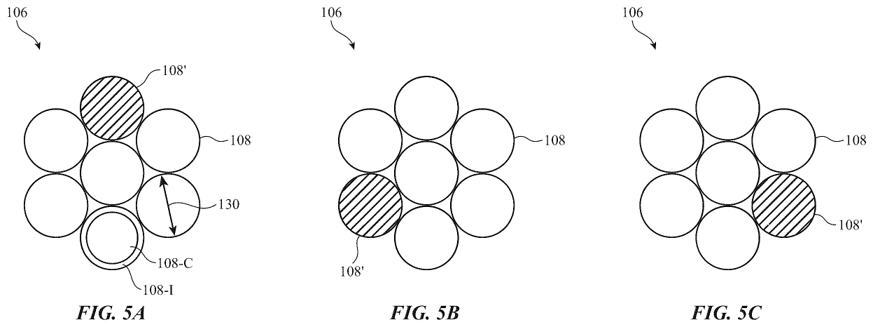

Twisting each wire subunit along a length of the wire subunit causes the radial position of the six wires 108 at the outermost periphery of each wire subunit to change as a function of length along that wire subunit. This is demonstrated in FIGS. 5A-5C. FIG. 5A is a cross-sectional side view of a single wire subunit 106 at a first point P₁ along the wire bundle. FIG. 5B is a cross-sectional side view of a single wire subunit 106 at a second point P₂ along the wire bundle. FIG. 5C is a cross-sectional side view of a single wire subunit 106 at a third point P₃ along the wire bundle. As shown in FIGS. 5A-5C, the radial position of a given wire 108′ within wire subunit 106 is different at the different points.

FIG. 5A further shows how each wire 108 may have a respective diameter 130. Diameter 30 may be between 20 microns and 100 microns, between 25 microns and 35 microns, between 45 microns and 55 microns, less than 100 microns, less than 70 microns, greater than 20 microns, etc. FIG. 5A further shows how each wire 108 may have a conductive portion 108-C and an insulating portion 108-I that extends around the circumference of the conductive portion 108-C. The conductive portion 108-C of each wire may be formed from copper or any other desired conductive material. The insulating portion 108-I of each wire may be a coating and may be formed from any desired insulating material.

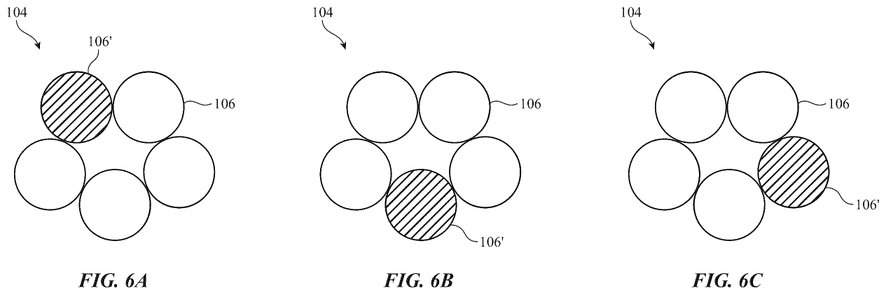

For each wire unit, twisting that wire unit along a length of the wire unit causes the radial position of the five wire subunits 106 to change as a function of length along the wire unit. This is demonstrated in FIGS. 6A-6C. FIG. 6A is a cross-sectional side view of a single wire unit 104 at a first point P₁ along the wire bundle. FIG. 6B is a cross-sectional side view of a single wire unit 104 at a second point P₂ along the wire bundle. FIG. 6C is a cross-sectional side view of a single wire unit 104 at a third point P₃ along the wire bundle. As shown in FIGS. 5A-5C, the radial position of a given wire 106′ within wire unit 104 is different at the different points.

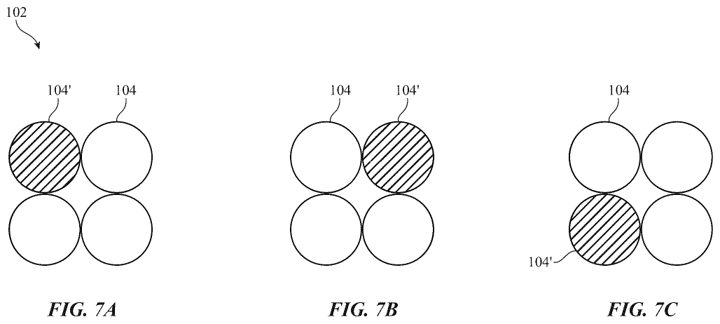

Twisting the wire bundle along a length of the wire bundle causes the radial position of the four wire units 104 to change as a function of length along the wire bundle. This is demonstrated in FIGS. 7A-7C. FIG. 7A is a cross-sectional side view of wire bundle 102 at a first point P₁ along the wire bundle. FIG. 7B is a cross-sectional side view of wire bundle 102 at a second point P₂ along the wire bundle. FIG. 7C is a cross-sectional side view of wire bundle 102 at a third point P₃ along the wire bundle. As shown in FIGS. 7A-7C, the radial position of a given wire unit 104′ within wire bundle 102 is different at the different points.

Forming the wire bundle using insulated conductive wires that are twisted to form wire subunits, which are twisted to form wire units, which are twisted to form a wire bundle may be a cost effective way to increase the variance in the position of each insulated conductive wire along the length of the wire bundle. Increasing the variance in the position of each insulated conductive wire along the length of the wire bundle may mitigate the proximity effect and accordingly decrease the resistance of coil 32 and increase the quality factor of coil 32.

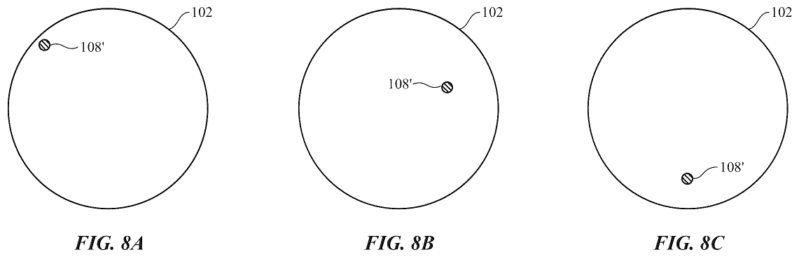

In one example, the wire subunit 106 from FIGS. 5A-5C is the wire subunit 106′ in FIGS. 6A-6C and the wire unit 104 from FIGS. 6A-6C is the wire unit 104′ in FIGS. 7A-7C. FIGS. 8A-8C show the variance in position of insulated conductive wire 108′ from FIGS. 5A-5C in this example. FIG. 8A is a cross-sectional side view of wire bundle 102 at a first point P₁ along the wire bundle. FIG. 8B is a cross-sectional side view of wire bundle 102 at a second point P₂ along the wire bundle. FIG. 8C is a cross-sectional side view of wire bundle 102 at a third point P₃ along the wire bundle. As shown, the position of wire 108′ within the cross-section of wire bundle 102 may vary as a function of length of the wire bundle. Because each wire subunit, each wire unit, and the wire bundle are all twisted, each given insulated conductive wire may be at any given position within the cross-section of the wire bundle at any given point along a length of the wire bundle.

In the example of FIG. 3, wire bundle 102 has four wire units 104, each wire unit 104 has five wire subunits 106, and each wire subunit 106 has seven wires 108 (e.g., a 4×5×7 arrangement). This example is merely illustrative. In another possible arrangement, wire bundle 102 has five wire units 104, each wire unit 104 has five wire subunits 106, and each wire subunit 106 has seven wires 108 (e.g., a 5×5×7 arrangement). In another possible arrangement, wire bundle 102 has four wire units 104, each wire unit 104 has six wire subunits 106, and each wire subunit 106 has seven wires 108 (e.g., a 4×6×7 arrangement). Other possible arrangements include a 6×6×6 arrangement, a 6×6×7 arrangement, a 6×7×6 arrangement, a 6×7×7 arrangement, etc.

The windings of coil 32 may include any desired number of turns of wire bundle 102 (e.g., three or more turns, eight or more turns, ten or more turns, eleven or more turns, twelve or more turns, twenty or more turns, fifty or more turns, etc.). Wire bundle 102 may include any desired number of wire units (e.g., two or more wire units, three or more wire units, four or more wire units, five or more wire units, six or more wire units, seven or more wire units, less than ten wire unites, less than eight wire units, etc.). Each wire unit 104 may include any desired number of wire subunits (e.g., two or more wire subunits, three or more wire subunits, four or more wire subunits, five or more wire subunits, six or more wire subunits, seven or more wire subunits, less than ten wire subunits, less than eight wire subunits, etc.). Each wire subunit 106 may include any desired number of wires 108 (e.g., two or more wires, three or more wires, four or more wires, five or more wires, six or more wires, seven wires or less, six wires or less, five wires or less, etc.).

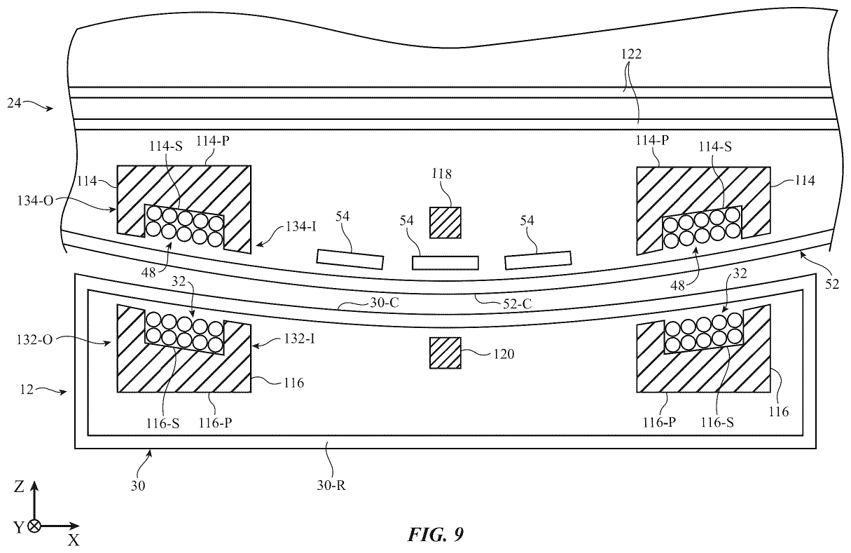

FIG. 9 is a cross-sectional side view of an illustrative wireless charging system with PTX 12 and PRX 24. In the example of FIG. 9, PRX 24 includes a single coil 48 and PTX 12 includes a single coil 32. Coils 32 and 48 may each be formed from wire bundles having the arrangement of FIG. 3.

As shown in FIG. 9, coil 32 may be positioned within a housing 30. Housing 30 may include one or more housing structures (e.g., formed from plastic, metal, glass, sapphire, and/or other desired materials). Similarly, coil 48 may be positioned within a housing 52. Housing 52 may include one or more housing structures (e.g., formed from plastic, metal, glass, sapphire, and/or other desired materials). Housing 30 may have a surface 30-C with concave curvature (sometimes referred to as concave surface 30-C) whereas housing 52 may have a surface 52-C with convex curvature (sometimes referred to as convex surface 52-C). Surface 30-C may have curvature that conforms to the curvature of surface 52-C.

As shown in FIG. 9, coil 48 may be positioned on magnetic core 114 and coil 32 may be positioned on magnetic core 116. The magnetic cores 114 and 116 may be formed from a soft magnetic material such as ferrite. The magnetic cores may have a high magnetic permeability, allowing them to guide the magnetic fields in the system. The example of using ferrite cores is merely illustrative. Other ferromagnetic and/or ferrimagnetic materials such as iron, mild steel, mu-metal (a nickel-iron alloy), a nanocrystalline magnetic material, rare earth metals, or other magnetic materials having a sufficiently high magnetic permeability to guide magnetic fields in the system may be used for one or more of the cores if desired. The magnetic cores may sometimes be referred to as ferrimagnetic cores. Each one of magnetic cores 114 and 116 may be a single piece or made from separate pieces. The cores may be molded, sintered, formed from laminations, formed from particles (e.g., ceramic particles) distributed in a polymer, or manufactured by other processes.

PTX 12 may include a magnetic alignment structure 120 and PRX 24 may include a magnetic alignment structure 118. FIG. 9 shows an example where additional input-output devices 54 are interposed between magnetic alignment structure 118 and surface 52-C. Magnetic alignment structures 118 and 120 may be permanent magnets (e.g., formed from hard magnetic materials that retain their magnetism over time) or other magnetic structures. During operation of wireless charging system, magnetic alignment structures 118 and 120 may attract one another (e.g., magnetically couple). When magnetic alignment structure 120 is magnetically coupled to magnetic alignment structure 118, concave surface 30-C may conform to and be in direct contact with the convex surface 52-C.

Core 114 may include a sloped surface that approximately matches the slope and/or curvature of surface 52-C (e.g., at a point at surface 52-C that overlaps coil 48 in the Z-direction). As shown in FIG. 9, PRX 24 may include one or more planar components 122. The planar components may include, as examples, a printed circuit board, a display panel configured to emit light in the positive Z-direction, a metal plate (e.g., to provide mechanical strength), etc. The planar components 122 are parallel to the XY-plane in FIG. 9. Core 114 may have a first surface 114-P that is parallel to planar components 122 and the XY-plane. Core 114 also includes a second surface 114-S that is at a non-parallel, non-orthogonal angle relative to planar components 122 and the XY-plane. Coil 48 is positioned on surface 114-S of core 114. Surface 114-S may sometimes be referred to as a sloped surface. The sloped surface may approximately match the slope and/or curvature of the portion of surface 52-C that overlaps surface 114-S in the Z-direction.

Core 116 may include a sloped surface that approximately matches the slope and/or curvature of surface 30-C (e.g., at a point at surface 30-C that overlaps coil 32 in the Z-direction). Housing 30 of PTX 12 may have a rear surface 30-R that is parallel to the XY-plane and planar components 122 when PTX 12 is attached to PRX 24. Core 116 may have a first surface 116-P that is parallel to rear surface 30-R and the XY-plane. Core 116 also includes a second surface 116-S that is at a non-parallel, non-orthogonal angle relative to rear surface 30-R and the XY-plane. Coil 32 is positioned on surface 116-S of core 114. Surface 116-S may sometimes be referred to as a sloped surface. The sloped surface may approximately match the slope and/or curvature of the portion of surface 30-C that overlaps surface 116-S in the Z-direction.

The angle between sloped surface 114-S and the XY-plane may be greater than 3 degrees, greater than 5 degrees, greater than 10 degrees, greater than 15 degrees, etc. The angle between sloped surface 116-S and the XY-plane may be greater than 3 degrees, greater than 5 degrees, greater than 10 degrees, greater than 15 degrees, etc. Surfaces 114-S and 116-S may be parallel or approximately parallel (e.g., within 10 degrees of parallel, within 5 degrees of parallel, within 3 degrees of parallel, etc.) when magnetic alignment structure 120 is magnetically coupled to magnetic alignment structure 118.

FIG. 9 shows how the number of layers of turns is wound in a consistent manner between the inner diameter of coils 32/48 and the outer diameter of coils 32/48. In the example of FIG. 9, there are consistently two layers of turns between the inner diameter of coils 32/48 and the outer diameter of coils 32/48. Maintaining a consistent number of layers of turns between the inner diameter and outer diameter mitigates parasitic capacitance that otherwise increases the resistance of the coils. The example of two layers of turns in FIG. 9 is merely illustrative. There may instead by exactly one layer of turns between the inner diameter of coils 32/48 and the outer diameter of coils 32/48, exactly three layers of turns between the inner diameter of coils 32/48 and the outer diameter of coils 32/48, or any other desired consistent number of layers of turns between the inner diameter of coils 32/48 and the outer diameter of coils 32/48.

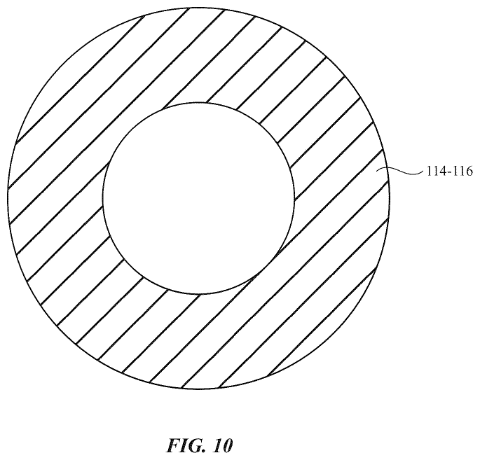

Each one of ferrite cores 114 and 116 may be ring-shaped, as shown in FIG. 10. The ring-shaped ferrite cores have a central opening that is aligned with a respective magnetic alignment structure. Magnetic alignment structure 118 is formed in the central opening of ferrite core 114 (and the central opening of coil 48). Magnetic alignment structure 120 is formed in the central opening of ferrite core 116 (and the central opening of coil 32).

In the example of FIG. 9, each one of cores 114 and 116 includes an inner lip and an outer lip. FIG. 9 shows how core 116 includes an inner lip 132-I and an outer lip 132-O. Each lip extends past surface 116-S in the positive Z-direction (e.g., in the direction of coil 32 and in the direction of the interface between the PTX and the PRX when the devices are attached). Coil 32 is therefore interposed between lips 132-I and 132-0. The coils may not extend past the upper surfaces of lips 132 in the positive Z-direction (e.g., in the direction of the interface between the PTX and the PRX when the devices are attached).

FIG. 9 shows how core 114 includes an inner lip 134-I and an outer lip 134-O. Each lip extends past surface 114-S in the negative Z-direction (e.g., in the direction of coil 48 and in the direction of the interface between the PTX and the PRX when the devices are attached). Coil 48 is therefore interposed between lips 134-I and 134-0. The coils may not extend past the upper surfaces of lips 134 in the negative Z-direction (e.g., in the direction of the interface between the PTX and the PRX when the devices are attached).

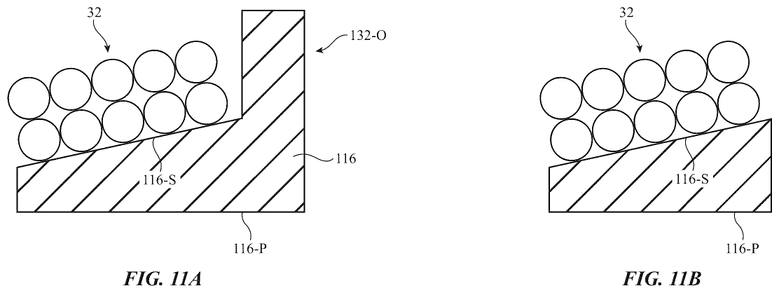

If desired, one or both of lips 132-I and 132-O may be omitted from core 116. FIG. 11A shows an example where inner lip 132-I is omitted and only outer lip 132-O is included in core 116. Lip 132-O extends past surface 116-S in the positive Z-direction (e.g., in the direction of coil 32 and in the direction of the interface between the PTX and the PRX when the devices are attached). On the inner side of the core, no portion of the core extends past surface 116-S in the positive Z-direction (e.g., in the direction of coil 32 and in the direction of the interface between the PTX and the PRX when the devices are attached).

FIG. 11B shows an example where both inner and outer lips 132-I and 132-O are omitted. In this example, no portion of the core (on either the inner diameter side or outer diameter side) extends past surface 116-S in the positive Z-direction (e.g., in the direction of coil 32 and in the direction of the interface between the PTX and the PRX when the devices are attached). Similar to as described in connection with core 116, one or both of lips 134-I and 134-O may be omitted from core 114.

The foregoing is merely illustrative and various modifications can be made to the described embodiments. The foregoing embodiments may be implemented individually or in any combination.

What is claimed is:

1. A wireless power transmitting device configured to provide wireless power to a wireless power receiving device, the wireless power transmitting device comprising:
a wireless power transfer coil; and
inverter circuitry coupled to the wireless power transfer coil, wherein:
the wireless power transfer coil comprises windings of a wire bundle;
the wire bundle comprises a plurality of wire units that twist along a length of the wire bundle;
each wire unit of the plurality of wire units comprises wire subunits that twist along a length of that wire unit; and
each wire subunit of the plurality of wire subunits comprises a plurality of insulated conductive wires that twist along a length of that wire subunit.

2. The wireless power transmitting device of claim 1, wherein the wire bundle has three or more wire units.

3. The wireless power transmitting device of claim 2, wherein each wire unit has three or more wire subunits.

4. The wireless power transmitting device of claim 3, wherein each wire subunit has three or more insulated conductive wires.

5. The wireless power transmitting device of claim 4, wherein the wire bundle has less than eight wire units, wherein each wire unit has less than eight wire subunits, and wherein each wire subunit has less than eight insulated conductive wires.

6. The wireless power transmitting device of claim 1, wherein the wireless power transfer coil has a plurality of turns between an inner diameter of the wireless power transfer coil and an outer diameter of the wireless power transfer coil and wherein the wireless power transfer coil has first and second leads at the outer diameter.

7. The wireless power transmitting device of claim 1, wherein each insulated conductive wire has a diameter that is between 20 microns and 100 microns.

8. The wireless power transmitting device of claim 1, wherein each insulated conductive wire has a diameter that is between 25 microns and 35 microns.

9. The wireless power transmitting device of claim 1, wherein each insulated conductive wire has a diameter that is between 45 microns and 55 microns.

10. The wireless power transmitting device of claim 1, wherein the wireless power transfer coil has one or more layers of turns of the wire bundle between an inner diameter of the wireless power transfer coil and an outer diameter of the wireless power transfer coil, and wherein a total number of layers of the wire bundle is consistent between the inner diameter and the outer diameter.

11. The wireless power transmitting device of claim 10, wherein the total number of layers of turns of the wire bundle is greater than or equal to two.

12. The wireless power transmitting device of claim 1, further comprising:
a ferrite core, wherein the wireless power transfer coil is a positioned on a surface of the ferrite core.

13. The wireless power transmitting device of claim 12, wherein the surface is a sloped surface.

14. The wireless power transmitting device of claim 12, wherein the surface is a first surface, wherein the ferrite core has a second, opposing surface, and wherein the first surface is at a non-parallel, non-orthogonal angle relative to the second surface.

15. The wireless power transmitting device of claim 12, wherein the ferrite core is ring-shaped.

16. The wireless power transmitting device of claim 12, wherein no portion of the ferrite core extends past the surface of the ferrite core in the direction of the wireless power transfer coil.

17. The wireless power transmitting device of claim 12, wherein the ferrite core has a first lip that extends past the surface of the ferrite core in the direction of the wireless power transfer coil, wherein the ferrite core has a second lip that extends past the surface of the ferrite core in the direction of the wireless power transfer coil, wherein the wireless power transfer coil is interposed between the first and second lips.

18. The wireless power transmitting device of claim 12, wherein the ferrite core has a central opening and wherein the wireless power transmitting device further comprises a permanent magnet in the central opening.

19. The wireless power transmitting device of claim 18, wherein the wireless power transfer coil is configured to provide the wireless power to an additional wireless power transfer coil in the wireless power receiving device during wireless charging operations, wherein the permanent magnet is configured to magnetically attract the wireless power receiving device, and wherein the surface of the ferrite core is parallel to an additional surface of an additional ferrite core associated with the additional wireless power transfer coil when the permanent magnet magnetically attracts the wireless power receiving device.

20. A wireless power receiving device configured to receive wireless power from a wireless power transmitting device, the wireless power receiving device comprising:
a wireless power transfer coil; and
rectifier circuitry coupled to the wireless power transfer coil, wherein:
the wireless power transfer coil comprises windings of a wire bundle;
the wire bundle comprises a plurality of wire units that twist along a length of the wire bundle;
each wire unit of the plurality of wire units comprises wire subunits that twist along a length of that wire unit; and
each wire subunit of the plurality of wire subunits comprises a plurality of insulated conductive wires that twist along a length of that wire subunit.
